(19) United States
(12) Patent Application Publication
(10) Pub. No.: US 2005/0004922 A1
(43) Pub. Date: Jan. 6, 2005

(54) Device, System and Method for Converting Specific-Case Information to General-Case Information

(75) Inventor: Uri Zernik, Palo Alto, CA (US)

Correspondence Address: LAW OFFICE OF JAY R. YABLON, 910 NORTHUMBERLAND DRIVE, SCHENECTADY, NY, 12309-2814, US

(73) Assignee: OPENSOURCE, INC., Menlo Park, CA (US)

(21) Appl. No.: 10/711,324

(22) Filed: Sep. 10, 2004

(51) Int. Cl. G06F 17/00

(52) U.S. Cl. 707/100

(57) ABSTRACT

Disclosed herein is device, system, method, and related user interfaces, for converting specific-case information to general-case information, comprising: identifying specific-case terms by scanning through a source document; proposing substitutions of general-case terms for the identified specific-case terms; and displaying the proposed substitutions.

### BACKGROUND OF THE INVENTION

In the era where information can be replicated and distributed widely and instantly, document re-use is an important concern. For example, in the world of national security, an analysis prepared primarily for a certain decision maker might include sensitive information regarding a political and/or military situation. When the document is to be re-used for another purpose, caution is necessary. For example, if the document is cleared for declassification, or for release to a congressional committee investigating a particular matter, it may still be imperative to hold back particular names and details. This invariably means that only a sanitized document is released, wherein certain categories of information, such as agents' names, places and dates where particular operations may have occurred, paragraphs that might reveal methods which are still in use, etc., must be redacted from the released document.

This cleanup process, herein called “sanitization,” and sometimes referred to as “anonymization,” is conducted to a large extent by humans and is fraught with error and high costs. During a recent high-profile rape trial, documents were manually reviewed and redacted by the court, and then made public. But the name of the accuser—which had hitherto been confidential—inadvertently remained on one of the released documents due to human error. The accuser's name thus became public knowledge to the severe embarrassment of the court, and to the accuser's own mortification.

Document re-use also arises in the legal marketplace. Due to the ever-increasing legal costs of drafting business contracts, law firms now keep a repository of their contracts in a firm-wide knowledge base. An attorney drafting a labor agreement for a certain state might save time and effort by consulting, and even cutting and pasting as is, relevant clauses from a similar contract in the same state.

However, this poses a serious problem for the law firm. Since the original contract contains the sensitive information about the parties and the agreed upon transaction, the parties may not wish to make the contract known to others. Indeed, a breach of this confidentiality may even rise to the level of malpractice. It may even be the desire of the parties not to have anyone know that they have even made an agreement, much less know the specifics of that agreement. Therefore, when depositing a contract in the repository, it is important to retain the underlying document stripped free of any information that can be used later on to figure out who the parties were and what they agreed to. Thus, information which either reveals the identify of the parties, or may be used by a good investigator to infer their identity from other particulars such as where the parties reside or when the agreement was signed, needs as well to be removed from the document.

Indeed, law firms invest thousands of dollars and many work hours in processes, training and technology to capture and leverage partners' knowledge. All too often these efforts stumble on the apparent inconsistency between sharing practice knowledge and keeping transaction information confidential. Confidential information may include deal identifiers, for example, but not limited to: price, company names and addresses, individuals' names, titles, and phone numbers (hereinafter called “private terms”). In many cases, sharing this information would be a breach of fiduciary duty. Removing it manually can be time-consuming and result in legal exposure through human errors.

In all of these situations, and in others, it is desirable to provide an automated, reliable device, system and method for sanitization, i.e., removing sensitive information from a document.

It will be appreciated, if the overall objective is thus to automate the process of sanitizing documents, that the issue of what is “sensitive” and thus needs to be sanitized or redacted may vary from one situation to the next. Also, the issue of what is “sensitive” may in fact involve some measure of subjective judgment. Thus, a statement that one of the parties resides in Delaware may be specific enough to allow a third party to figure out from a combination of other factors who that party is. But, since very many companies incorporate in Delaware, it may not be necessary to remove the word “Delaware” when it is used in that latter context.

It is also a tough challenge to identify names. Consider for example the task of identifying company names. One approach is to use a database of existing companies. But unfortunately, many contracts are written for start ups at their moment of inception, when they are not even listed in any databases, much less household names. A second approach is to use company-name grammar, i.e., identify names such as “Wilson, Sonsini, LLC”, or “OpenSource, Inc”. But this approach will miss names such as “Blue Martini” or “Boston Market”. There are other statistical approaches, but obviously, it is impossible to come up with a method that will identify company names at a certainty of 100%. Therefore, it is impossible to rely on a method that is fully automatic, and it is necessary to devise a methodology of keeping the human in the loop.

It is therefore desirable to provide a device, system and method which enables specific-case, often sensitive information to be automatically removed from a document.

it is further desirable to enable the user to control this process, so that the automated system provides a structured methodology to vastly improve the user's sanitization work in terms of time, efficiency, and accuracy, but ultimately leaves room for that user's human judgment and organizational information release policies.

### SUMMARY OF THE INVENTION

Disclosed herein is a device, system and method for converting specific-case information to general-case information, comprising: identifying specific-case terms by scanning through at least one source document; proposing substitutions of general-case terms for the identified specific-case terms in the at least one source document; and displaying the proposed substitutions.

Also disclosed is a related interface, comprising: displaying a source document; displaying within the source document, general-case terms proposed to be substituted for specific-case terms originally existing in the source document; and further displaying a proposed substitution list listing the general-case terms in relation to the specific-case terms for which they are proposed to be substituted.

Also disclosed is a related interface, comprising: displaying at least part of a source document; displaying within the source document, specific-case terms for which it is proposed to substitute general-case terms; further displaying at least part of a proposed substitution document; and displaying within the proposed substitution document, the general-case terms proposed to be substituted for the specific-case terms, juxtaposed relative to the specific-case terms to facilitate comparison between the specific-case terms and the general-case terms.

Also disclosed is a related interface for use for a plurality of documents, comprising displaying on a computerized display device, a proposed substitution list listing general-case terms proposed to be substituted for specific-case terms originally existing in a batch plurality of source documents, in relation to the specific-case terms for which they are proposed to be substituted, based on processing by a computer processor.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) in which:

FIG. 1 is a schematic illustration of a client-server architecture employed for use of the various invention embodiments, over a network connection. It is readily understood that these invention embodiments can also be provided by installation directly onto an individual computer.

FIG. 2 is a flowchart illustrating the generation and updating of various underlying databases used in accordance with the device, system and method disclosed herein.

FIG. 3 is a flowchart illustrating the primary functions of the underlying algorithm from initialization of the specific-case term identification process to the proposing of substitutions.

FIG. 4 is a flowchart illustrating the user experience, that is, the steps which the user takes from initialization of the removal process to completion of substitution.

FIG. 5 is an illustrative screen shot showing a three-pane management screen for use in sanitizing a document. The upper-left pane is a context screen, the upper right pane shows the document with proposed substitutions for review by the user (document pane), and the lower pane shows a substitution list pane enabling user review and modification to the proposed substitutions.

FIG. 6 is an illustrative screen shot showing a document comparison window comprising a side-by-side (juxtaposed) view of all substitutions of a selected single term, that is, showing the paragraphs which include substitutions of the selected term, side-by-side with the original source document.

FIG. 7 is an illustrative screen shot showing a finalized document in which all sensitive (specific-case) words are replaced by dummies. This document is “safe” to place in a general repository, because sensitive identifiers have been sanitized from the document.

FIG. 8 is an illustrative screen shot showing a finalized form. Each one of the form fields stands for an item which may be filled in according to the parties and transaction details for a particular future use of the form.

### DETAILED DESCRIPTION

Based on the background earlier discussed, it will be appreciated that there are different types of information which may be sensitive in various situations, and that it is important to identify these information types. Certainly, names and addresses are particularly sensitive, and thus will need to be removed in many situations. But, if this removal process is to be automated, it becomes important for a computer processor to be able to scan through a document and discover what is a name, and what is an address. In general, there are three overall approaches to doing this, and these approaches are best used in a complementary manner to one another.

First, one may use context as a means of identifying particular types of information. Thus, in a legal contract, it is known that the preamble will be structured in a certain way to set forth many of the specifics of the transaction, and thus, by parsing the preamble, one can ascertain right away certain names, addresses, etc. which it is critical to remove, not only from the preamble, but from throughout the document. Similarly for a signature block at the end of a contract. If one were to sanitize, say, a patent application, one might look for the “Cross Reference to Related Applications” section, and know that patents cited in that section need to be removed, whereas patents cited later in the document as prior art may be allowed to remain.

Second, one may use grammar patterns which generally indicate names, addresses, and like information. For example, it is known that addresses in the United States are set out in a particular, widely-recognizable format, and so programming which allows something to be flagged as an address will be of value in performing such sanitization.

Third, one may use large databases. For names and addresses, for example, once may wish to have available an extensive database of names, and an extensive database of streets and cities. Then, a particular word suspected to be part of, e.g., an address, can be compared to a database for further confirmation that this word is indeed part of an address.

Other types of information which often embody something which is sensitive and therefor ought to be removed from a sanitized document include, but are not limited to, monetary values such as price (or generally, numbers), corporate titles, telephone numbers and dates. Scan rules involving grammar and context, and which also make use of large underlying databases of these information types, can help to identify these types of information for sanitization as well.

Collocation is another area of interest in considering document sanitization. Even though “round” and “table” and “pizza” by themselves are innocuous enough, the collocation “Round Table Pizza” is the proper name of a business, and so is a strong candidate for sanitization. Thus, a collocation database—that is—a database of terms which are often collocated into an identifier that goes beyond the sum of the individual words, is also among the databases which are useful to the sanitization process.

Rare word usage is another basis for sanitization. In particular, commonly-used words are more likely to be generic and not sensitive, while a rarely-used word is more likely to be sensitive and therefore in need of sanitization. Thus, if the usage of a particular word falls below a certain predetermined statistical threshold, it may be desirable to flag that word for sanitization.

It should be apparent by this point that the use of various types of databases is an important component of any effective document sanitization. This begs the question, from whence are these databases derived? While a comprehensive dictionary can be used to identify ordinary words which in many cases are not sensitive, the databases of most interest for sanitization will often contain just the opposite: words which are not ordinary dictionary words but which are some other type of word, such as a name, or an address, or a place, or a rare word.

Thus, it is important to provide an underlying body of data based on such things as census data, postal directories, etc., which can aid in identifying words and terms more likely to be sensitive.

Rare word usage presents a particular challenge, since statistics on usage are not universal, and usage frequency for a given word or term in one context (i.e., law) will vary vastly from usage in a different context (e.g., poetry). Thus, it is helpful to have available a large corpus of like-documents, and to derive usage statistics directly from that corpus. Thus, if one is sanitizing legal contracts, it is best to utilize usage statistics from a large corpus of legal contracts. If one is sanitizing patent documents, then a large corpus of patent documents is called for. If one is sanitizing national intelligence documents, then a large corpus of national intelligence documents is most appropriate. And so on.

It was also noted that often the question of what to sanitize is subjective, and that one person may wish to sanitize certain information where another person may not. One of the central problems in any type of machine-based classification system is how one draw the line between “false-positives” and “false-negatives.” It is optimum, of course, to maintain both of these as close to zero as possible. And, if confidentiality is particularly important, then it is desirable to err on the side of false positive (sanitizing something which really does not need to be sanitized) than false negative (releasing something which should have been sanitized). This can be addressed in several ways.

First, this may be addressed by the user raising or lowering the predetermined statistical threshold which is used to establish a rare word or a rare collocation. A rare word threshold of 600 usages per billion, for example, will sanitize many more words than a threshold of 30 usages per billion.

Second, this may be addressed by the user to establishing “preferences” regarding the types of data to be sanitized. Thus, a particular user may consider it desirable to remove all street addresses and city names, but not the states, and thus establish a corresponding default preference. A different user may remove only street addresses, but allow city and state to remain. This is just one example. The wider issue is that in varying situations, and for varying users, certain types of information may be more or less sensitive, and it is desirable to allow the user to sanitize based on these preferences.

Third, this may be addressed manually. That is, after the computer has done an automated scan through a document and picked out certain terms to be sanitized, it is desirable to present these to the user as “proposals” for review. At that point, the user will need a good interface through which the proposed sanitization may be reviewed and modified (overridden). The user may wish to sanitize some information that has not been proposed for sanitization (false negative), or the user may wish to refrain from sanitizing some information which has been proposed for sanitization (false positive). Finalization of the proposed sanitization should thus occur only after the user has had a chance to review and manually modify what the automated process has proposed.

Fourth, this may be addressed through a machine-learning feedback processes, to better avert false positives and false negatives, which is at the heart of machine-based classification. Thus, as a user establishes various preferences, and as a user manually overrides certain proposed substitutions (which indicates as false positive or a false negative), it is important to automatically learn from these, so that classification accuracy is increased over time. (See, e.g., Salton, Gerald, “Automatic text processing”, Addison-Wesley Longman Publishing Co., Inc. Boston, Mass., 1988)

It is also fruitful to observe the close nexus between sanitizing documents to remove sensitive information, and converting a specific document into a more general document. The production of legal forms is a very good example. If one has a specific contract representing a transaction between two parties which has sensitive information about the parties, but while also is a good generic document for that particular type of contract once the specific transaction information has been removed, then sanitization can be seen more generally as a subset of the task of converting sensitive, specific-case information to non-sensitive, general-case information.

Particularly, the words and terms in a document which are most likely to be sensitive and therefore in need of sanitization, are the words and terms which are specific to that document: who the parties are, what their addresses are, what price they settled on, what quantity of goods was exchanged, etc. On consideration it will be appreciated that these will overlap very closely with—and may even be identical to—the words and terms that would need to be removed from the document to turn it into a “form” which can be reused for other like transactions—but between different parties and on different terms—in the future.

From this more global viewpoint, sanitization and the generation of forms can both be understood as requiring identification of that information within a document which is invariant from one transaction to another and therefore does not need to be and ought not be removed from the document, in relation to that information which is a specific instance and thus needs to be removed from the document. By removing specific-case terms and not removing general-case terms, one guards against the revelation of specific information if sanitization is the objective, and produces a suitable generalization of the document if form production is the objective.

The situation in which sanitization and form generation may diverge, is when certain information, while specific, is not considered to be particularly sensitive, and thus is left in the document (not sanitized) by the choice of the user. Thus, using the example provided earlier, a user may decide to leave the name of a state in a sanitized document after having made the judgment that the state name is not really a sensitive item. But, if the underlying document is to be used as a form for like transactions involving a party in a different state, then the state name needs to be removed for form generation, whether or not the state name is regarded as “sensitive” for sanitization.

In this way, it can be understood that sanitization and form-generation will converge into the same operational task, in those situations where sensitivity is set to the highest level, that is, in those situations where every item of specific-case information is removed from a document.

Thus it may be seen that the underlying task in all instances, is that of converting specific-case information to general-case information, that is, of removing information from a document which provides specific identifiers of people, places, dates, amounts, etc., and substituting general information (e.g., dummy variables and/or blank spaces) in its place, to produce a document containing generalized information which is non-specific to any given situation or transaction. And, of course, it is desired to perform this task automatically, but under the control of a user who can make the final decisions about what information does and does not get removed in the end.

It will be appreciated from all of the above that sanitization is a difficult task, since it is inherently open-ended. There is no close-ended list of items, or even types of sensitive items. Therefore it is challenging to establish a checklist of items to be sanitized from documents, i.e., converted from sensitive, specific-case information to non-sensitive, general-case information. And similarly, it is difficult for a computer program to identify and sanitize all such items. Additionally, as noted, it is also desirable to be able to start with a specific-case document, remove all specific-case information to produce a general “form document,” and thereafter use the form document as the basis for filling in a different, specific-case information set.

In light of the foregoing, the device, system and method disclosed herein for sanitizing documents addresses two primary tasks, each with a similar underlying processing basis. First, sanitizing a document to protect sensitive information. This entails identifying sensitive, private, transaction-specific terms and substituting generic, “dummy” terms in their place. Second, turning a specific-case document into a generic form. This entails identifying transaction-specific terms and turning them into fields which may later be filled in.

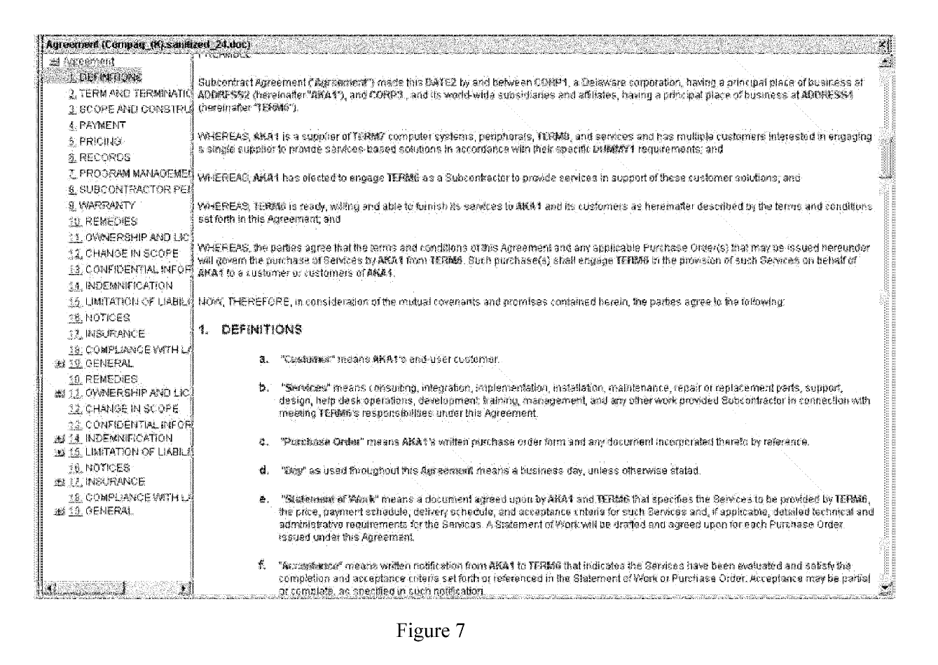

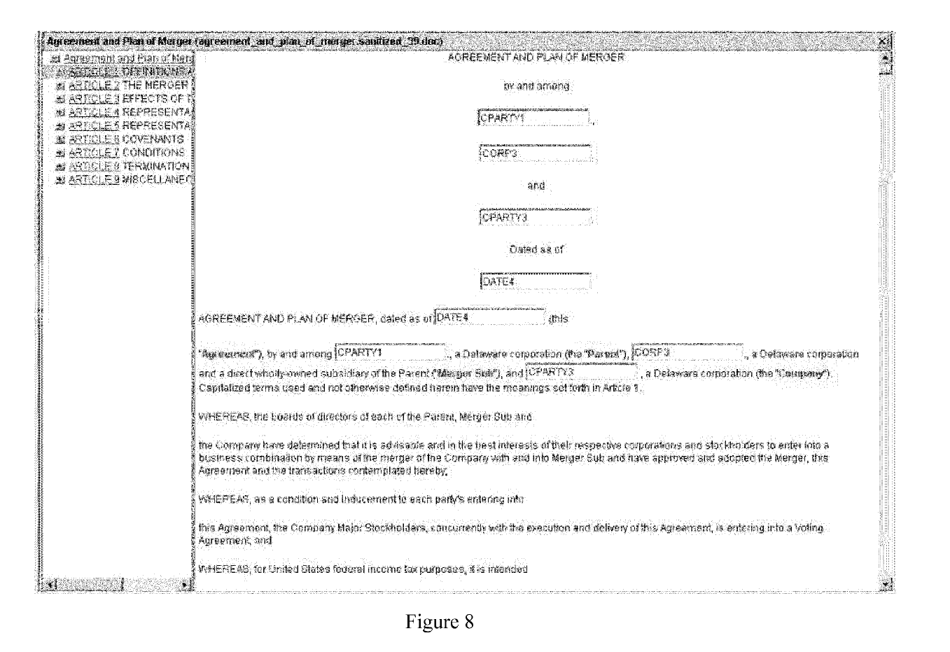

These two tasks use the same method, although the output format is slightly different (see FIGS. 7 and 8). It will be appreciated that in each case, it is important to separate those parts of the document which are generic, that is, which will remain constant irrespective of such details as the names of the parties, the prices being paid, the length of time for certain actions to occur, etc., from those parts of the document that are specific, that is, which will change from one circumstance to the next. For sanitizing, this separation serves to distinguish those parts of the document which are “sensitive” and therefor need to be treated confidentially by redaction, from those parts which can remain intact and be circulated without revealing sensitive information. For generating forms, this separation serves to distinguish those parts of a document which will change from one situation to the next and thus need to be filled with “blanks,” from those parts of a document which are substantially unchanged from one situation to the next and thus constitute the invariant content of the “form.”

FIG. 7 shows a finalized, sanitized document, where private terms are uniformly removed, and dummy terms, which for illustration are shown in bold typeface, are substituted throughout the document. Of course, for all occurrences of a particular specific-case terms, a uniform general-case term is substituted. For example, the company names are uniformly replaced by CORP1 and CORP3 throughout the document.

FIG. 8 shows a finalized sanitized document, but where private, specific-case terms are uniformly substituted by fields which contain dummy terms. The party names, for example, are uniformly replaced by CPARTY1 and CORP3 as the background filler of the blank field. Linkages are maintained among all occurrences of a particular specific-case term, so that as soon as this field is filled in one location in the form, all other associated fields are filled in in the same manner. Thus, entering a specific company name, for example, in any of the fields for the company name, will cause that same company name to show up in all other appropriate places in the form. As a consequence, it will be appreciated that in form mode, one may start with a specific document, generalize that document, and then easily and quickly return to a different specific case by filling in the generalized specific-case fields.

By maintaining these linkages among all occurrences of a particular specific-case term, one may simply run a sanitation program, pass the generated linkages to a computerized form program, and then, via the form program, enter a new specific-case term into a single field, and automatically fill that new specific-case term into all of the form fields linked to that single form field, using the computerized form program.

In summary, the device, system and method disclosed herein enables automatic removal of private information from transaction documents, to preserve confidentiality, and to easily generate forms from specific-case documents that can thereafter be used to establish new specific-case document based on the generated forms.

Additionally, the device, system and method disclosed herein facilitates a cycle of manual corrections which allow the treatment of false positives (terms that were superfluously substituted by the program), and false negatives (terms that were overlooked by the program).

As used herein, the word “term” is used to designate one word, or several words. Thus, a “specific-case term” is a single word or a collection of several sequential words which embodies specific information that lends itself to being sanitized from a document. A “general-case term” is a single word or a collection of several sequential words which is substituted as a “dummy” for a specific-case term. The point, however, is that the use of the word “term” is not limited to a single word, or to several sequential words, but rather, encompasses both.

This manual correction cycle, in a preferred embodiment, includes but is not limited to the following capabilities:

Substitution of sensitive information: to reduce exposure and increase efficiency, sensitive information may be automatically substituted with dummy terms of the user's choice. Such information may include deal, company and personal identifiers.

Change report: to ensure accurate information removal, the system generates an automatic report, showing the substitutions made and allowing for user-driven changes to those automatic substitutions.

Reject current substitutions: for full control of the document, users can remove superfluous substitutions. That is, the user may undo a proposed substitution by designating a proposed substitution to be undone, using a computerized input device.

Add new substitutions: users can also add overlooked substitutions. That is, they may add a substitution by designating a substitution to be added, using a computerized input device.

Change dummy terms: users can change dummy terms to reflect their objective. For example, the generic term DUMMY0 can be changed (uniformly, across the board) to MyDummy. That is, they may modify a proposed substitution by designating a proposed substitution to be modified, using a computerized input device; and entering a modification to that proposed substitution, also using the computerized input device.

We now examine all of this in further detail.

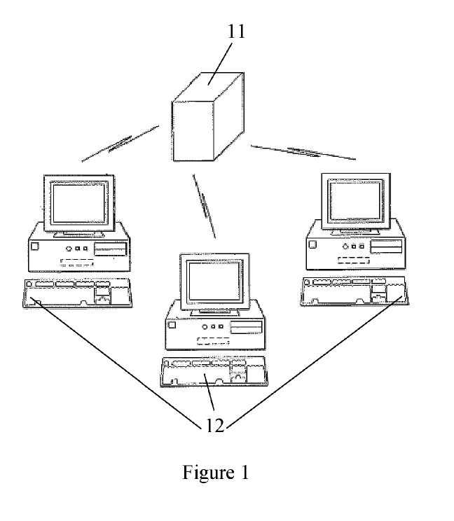

FIG. 1 is a schematic illustration of a client-server architecture employed for use of the various invention embodiments, over a network connection. Illustrated is a server 11, connected over telecommunications links to a plurality of browser-based clients 12.

The computer software incorporating this functionality may be provided as a server-based software application accessible over the Internet, preferably, requiring nothing more that a standard browser, as illustrated in FIG. 1. It can be accessed and used by multiple users at one time.

This software may also be provided for installation directly on a user's computer, through standard installation media such as a CD, or a set of installation files downloaded over a telecommunications link such as an Internet connection.

Irrespective of configuration, processing is performed by a computer processor. A computerized display device such as a computer monitor or a computer printer is used to display information, and a computerized input device such a mouse or a keyboard is used to enter information. It is to be understood that the term “computerized input device” may refer to more than a single discreet hardware device. Thus, for example, the commonly-employed mouse/keyboard combination is considered to be included within the term “computerized input device.” The computerized apparatus referred to herein includes any and all of the above, as well as any associated telecommunications links, and fixed or removable storage devices. It also includes devices which may not necessarily be “desktop” or “laptop” computers, such as television-type computers, and handheld (palm-type) computers. Computerized output devices, in addition to monitors and printers, may also include removable disks, and well as telecommunications links which transmit information from the computerized apparatus to another computerized apparatus.

To minimize adoption costs, this software can be integrated with and invoked from within a word processing document in a commercially-available word processor such as, but not limited to, Microsoft® Word®, and the final “sanitized” document may be presented in that same word processor.

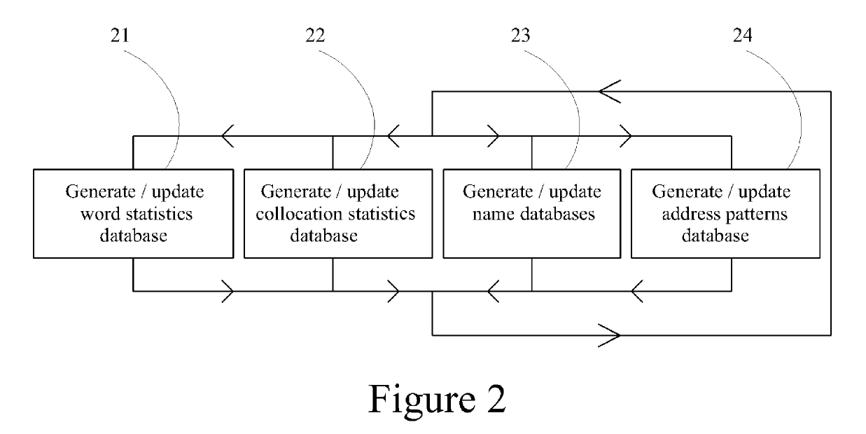

FIG. 2 illustrates the generation and updating of various underlying databases use in connection with the various embodiments disclosed herein. As noted earlier, it is preferred to generate several databases from a large corpus of like-documents. Thus, at 21, a statistical database of words usage is generated from the corpus of like documents. For each word, this database specified how frequently this word appears in the corpus. As noted earlier, infrequent usage correlates to a higher likelihood that the word needs to be sanitized. At 22, a collocation database is generated from the corpus of like documents. At 23, various name databases are developed from sources such as name lists (e.g., telephone directories, census data), street lists (e.g., postal directories), etc. At 24, a pattern database is developed from patterns known to represent addresses.

All of these databases are in existence before any individual document is sanitized. These databases may be updated over time, for example, as the corpus is increased with additional documents, as new telephone or postal census data is released, etc.

The suitable collection of data is examined, for example, in Witten, Ian; Moffat, Alistair; and Bell, Timothy, “Managing Gigabytes,” Morgan Kaufman Publishers, San Francisco, Calif., 1999.

It is worth noting that, in one preferred embodiment, collocations are identified using, for example, the Mutual Information Formula:
MI(x, y)=P(x, y)/(P(x)*P(y))
where P(x) is the frequency of use in a corpus of word x, P(y) is the frequency of use in that same corpus of word y, and P(x, y) is the frequency of use in the same corpus of word x immediately followed by word y. (See, e.g., Zernik, Uri, editor, “Lexical Acquisition: Using On-Line Resources to Build a Lexicon”, Lawrence Erlbaum Associates, Inc., Hillsdale, N.J., 1991. See also, Dunning, Ted, “Accurate Methods for the Statistics of Surprise and Coincidence,” Computational Linguistics, pp. 61-74, Volume 19, Issue 1, (March 1993), MIT Press, Cambridge, Mass., 1993.)

For example, the most frequently-used pair of words in English-language documents is “of the.” P(of)=1/15, P(the)=1/10, and P(of, the)=1/50. That is, “of” appears as every fifteenth word, “the” appears as every tenth word, and “of the” appears as every fiftieth pair of adjacent words. Hence, MI(of, the)=(1/50)/(1/10)*(1/15)=3.

On the other hand the MI for “Hoi Polloi” is much stronger. P(Hoi, Polloi)=1/100,000,000; P (Hoi)=1/100,000,000, and P(Polloi)=1/100,000,000. Therefore, MI(Hoi, Polloi)=100,000,000. Essentially, this means that Hoi and Polloi always appear next to each other, and so are both highly collocated and very rarely used.

Somewhere in the middle is “General Electric” which has an MI around 1000. By establishing a suitable MI threshold one can stop “of the” from being treated as a collocation and sanitized, while one can ensure that “Hoi Polloi” and “General Electric” are treated as collocations and sanitized.

First, MI classifies a group of words as a term. The higher the MI, the more likely the term is a collocation. Then, rarity and relative frequency are used to decide whether or not to propose that term for sanitization.

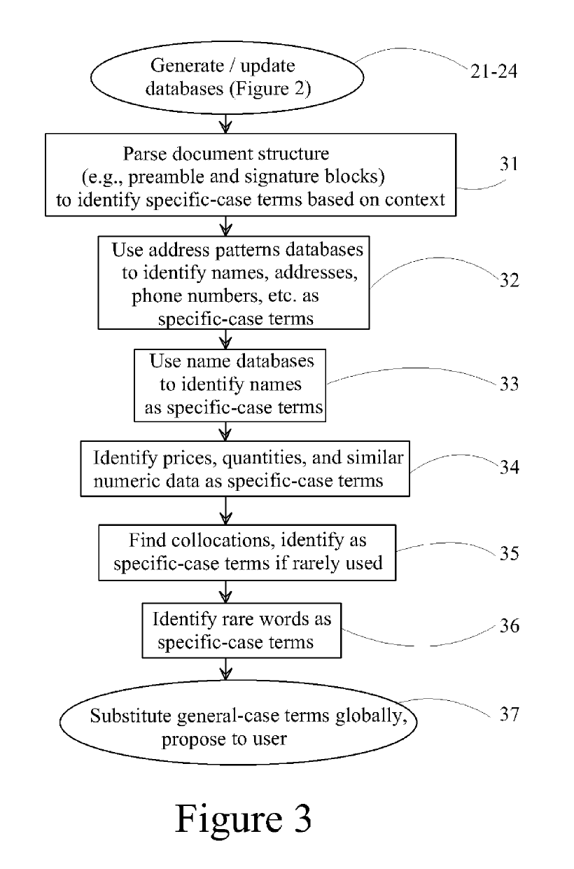

FIG. 3 is a flowchart illustrating the primary functions of the underlying algorithm. This algorithm is based on five kinds of knowledge:

1. Name Database (at 33): The words John and Mary, Smith and Pennsylvania are identified as names, which are regarded as specific-case information and are thus are proposed to be sanitized. The underlying name database is collected from large numbers of documents of similar nature to the document being sanitized. For example, for use in connection with legal contracts, the name databases are collected from a “corpus” of numerous (perhaps tens, hundreds, thousands, tens of thousands, hundreds of thousands, millions, or more) legal contracts. Also, name databases may be provided from or supplemented by other sources, such as the Census Bureau, telephone directories, and any other source in which name information is commonly listed. Cities, states, provinces, countries, and other political entities are similarly included in this database.

El-Yacoubi, Mounim A.; Gilloux, Michel; and Bertille, Jean-Michel, “A Statistical Approach for Phrase Location and Recognition within a Text Line: An Application to Street Name Recognition,” IEEE Transactions on Pattern Analysis and Machine Intelligence, Volume 24, Issue 2 (February 2002) pp. 172-188, IEEE Computer Society Washington, D.C., 2002, provides further discussion of issues involved in name, address, and similar types of recognition.

2. Grammar Pattern (at 32): address, name, and other quantities have a unique grammar.

a. Address Patterns: the term “2231 South Court” is identified as an address. Addresses may be collected from contracts. Additionally, they are collected from the U.S. Postal Service, and from postal services for countries around the world.

b. City, State, Zip Pattern: “SJ, Calif. 94301” is identified as a city, state, zip pattern. SJ, Calif. is a city, state pattern. Worldwide, these identifiers are generalized to postal patterns and postal codes.

c. Price Pattern: $23.00 is identified as a price (at 34)

d. Name Pattern: “World B. Free” is identified as a name

e. Date Pattern: “Jan. 10, 1987” is identified as a date.

3. Document Structure (at 31):

a. Paragraphs such as the one below are identified as a preamble

“The Contract is between Green, Green and Green (“GGG”) AND Yellow Color (hereafter known as “YC”) located in 1231 Barry Street, San Jose, Calif. 12341”.

In a preamble, the terms “Green, Green, and Green” and “Yellow Color” are identified as names. “YC” and “GGG” are identified as aliases, also to be sanitized.

b. Paragraphs such as the one below are identified as a signature block

Undersigned:

Name: John B Smith

Signature ______

Date: Oct. 4, 1967

As such, the name, signature, and date fields are to be sanitized.

More generally, this involves identifying a particular section of the source document as being a section customarily containing specific-case terms; and identifying a term as a specific-case term based on that term being located in the identified particular section at a place customarily occupied by specific-case terms.

Suitable methods for such parsing are discussed, for example, in Salton (1988), earlier cited.

4. Collocation Database (at 35):

The terms “Round Table Pizza” and “Seven Sisters” are identified as collocations, since they appear collocated together disproportionately frequently in the corpus of similar documents, as discussed above. Whether to sanitize these terms is then based on their rarity and relative frequency of use in relation to a predetermined threshold. Note, if a collocation appears in the name database, then sanitization will already have been initiated from the name database (box 33).

5. Word Frequency (at 36):

Word which rarely appear (rare words) are to be sanitized, based on the supposition that these words are likely to be specific-case rather than general-case information. For example, the words “Kilcline”, “Riverside”, and “Combersume” are found to be rare words, and as such they are sanitized.

Manning, Christopher D. and Schutze, Hinrich, “Foundations of Statistical Natural Language Processing”, The MIT Press, Cambridge, Mass., 1999, provides further insight into suitable methodologies for identifying rare words.

The algorithm then works in three steps:

a. Pre-processing (21-24): Collect collocation, word, name, and grammar pattern databases by poring over a “balanced” corpus of similar documents to the document type to be sanitized.

b. Specific-Case Term Identification (31-36): Identify specific-case terms based on the 5 knowledge sources above.

c. Proposed Global Substitution (at 37): Take identified specific-case terms, remove them, and substitute or provide a form blank for them globally across the document. Additionally, this is done for prices, quantities and similar numeric information items (at 34).

Note that although FIG. 3 illustrates a particular order of algorithm steps, this order can be varied, or processing can be done in parallel, all within the scope of this disclosure and its associated claims. In the end, the words and phrases which are removed/substituted at 37 are those which have been flagged in any of boxes 31 through 36.

It is worth noting that in a certain sense, the device system and method disclosed herein is a sophisticated global search and replace engine, including a novel and nonobvious user interface for driving that search and replace engine. In contrast to preexisting global search and replace engines in which the user enters a term as well as the replacement to be globally applied to that term, according to this disclosure it is the computer itself which first scans the document, decides which terms to replace based on via steps 21 through 24 and 31 through 36 as detailed above, and then proposes such replacement to the user. Thus, is a conventional search and replace function, the user tells the computer terms to replace, and what to replace them with. Here, the computer asks the user. That is, the computer formulates a hypothesis about what terms ought to be replaced (identifying specific-case terms by scanning through a source document using a computer processor) as well as terms to replace them with, and asks the user whether or not to go ahead with these replacements (proposing substitutions of general-case terms for the identified specific-case terms, also using the computer processor; and displaying the proposed substitutions on a computerized display device).

In particular, the computer scans through the document and flags a term for replacement by comparing each word or section of words to databases derived from an extremely large corpus of material including like-documents, word dictionaries, name lists, address lists, collocation lists, etc. and obtaining a “hit” in one or more of those lists. The computer also flags term based on context, for example, a preamble or signature block of a legal contract. Or, for example, the cross-reference to related applications of a patent document. And, the computer flags terms or collocations for replacement based on rarity of usage, based on the supposition that if a term is rarely used (usage below a statistical predetermined usage threshold) it is likely to be a specific-case (sensitive) rather than a general-case (non-sensitive) term.

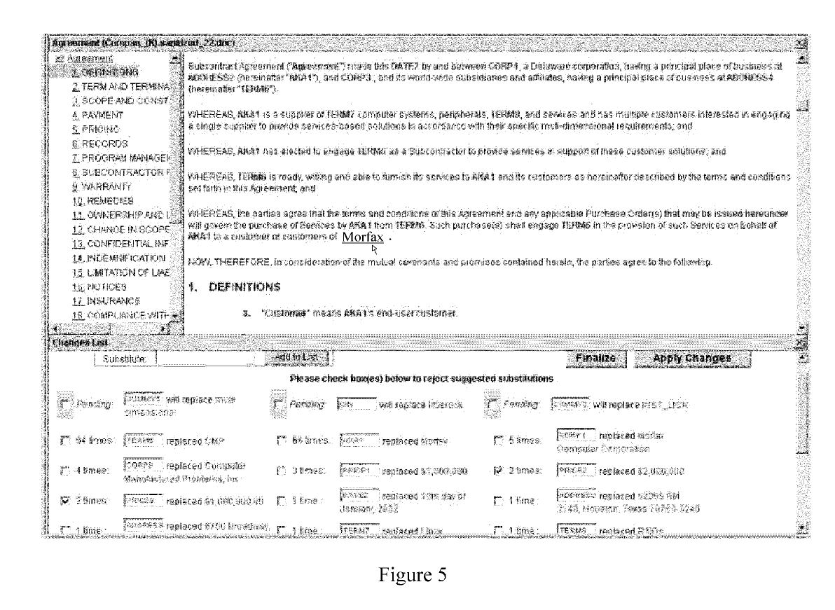

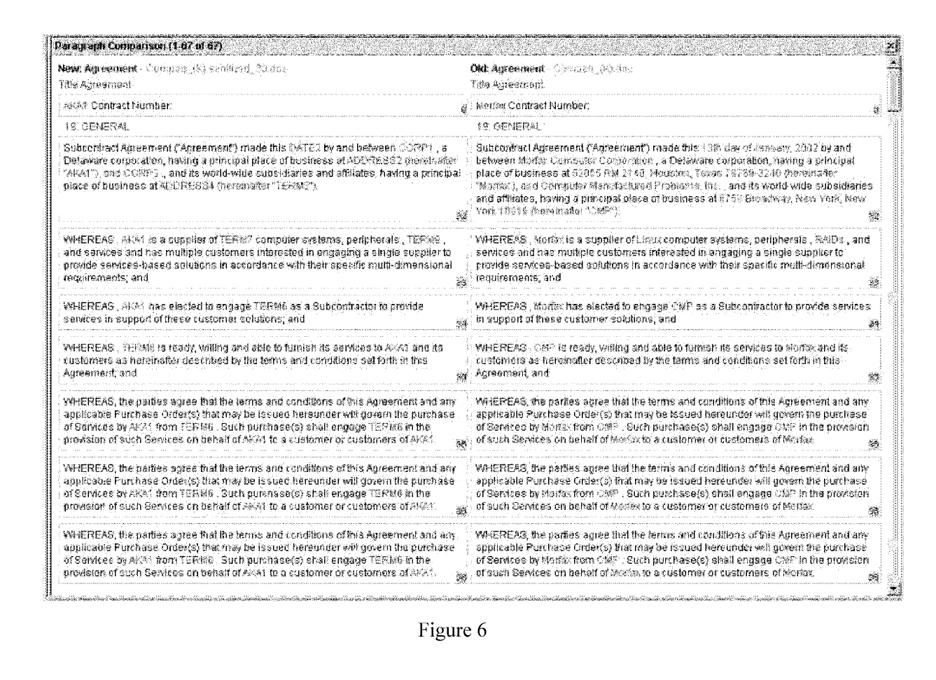

Global replacements are then made automatically to all occurrences of terms identified for replacement during the scan, and displayed to the user as proposed substitutions which can then be manually amended by the user. For any given source term, the replacement for that term is made globally with an identical replacement term (uniform substitution). This of course makes perfect sense in terms of maintaining the intelligibility of the document, but it also thereby preserves linkages among all original occurrences of a given substituted term. Thus, in a display such as that of FIG. 5, it is possible to generate a proper substitution list including the number of occurrences of each proposed substitution, and in the case of a display such as that of FIG. 6, it becomes possible to display multiple occurrences throughout the document of a particular substitution. And, if a form is to be generated, it enables the filling of a single blank in the form to propagate to all other places in the document to which that filling in ought to propagate.

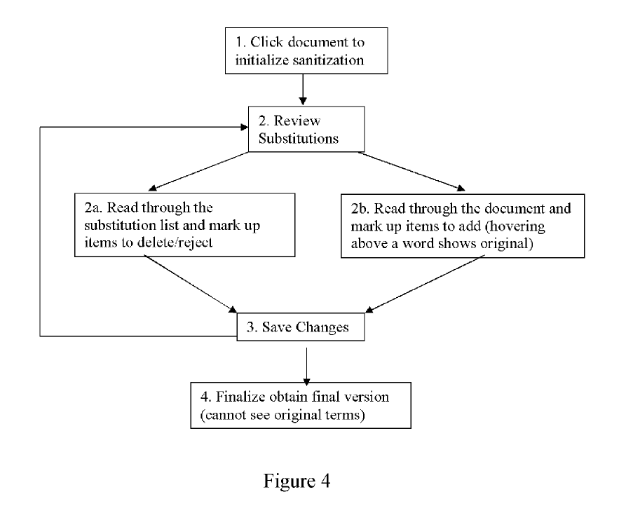

FIG. 4 is a flowchart illustrating the user experience.

In FIG. 4, box 1, the user clicks on the document he/she wants to sanitize.

As a result, user obtains a split screen such as that illustrated in FIG. 5, so that he or she may review a set of proposed substitutions. The top right pane shows the sanitized document in draft (non-finalized) form. In this pane the old sanitized terms are substituted by new, highlighted “generic” labels (these are shown in bold in the illustration, but it is recognized that a wide range of highlighting schemes may be employed within the scope of this disclosure.). Preferably, the old terms can be viewed by hovering the user input device (e.g., cursor) over the highlighted terms, as illustrated. Thus, when the cursor is moved over AKA1, the original, sanitized term “Morfax” will appear. The bottom screen contains a substitution list showing the tally of the substituted words—for example, AKA1 replaced Morfax 66 times throughout the document.

In FIG. 4, box 2a, the user looks for terms that were sanitized incorrectly (superfluously) by the system (false positives). For example, “$1,000,000.00” and “$2,000,000,” in his/her opinion, should not have been sanitized. By clicking the checkboxes near PRICE2 and PRICE3, the user can undo this substitution (a checkmark means that the substitution is undone).

In FIG. 4, box 2b, the user looks for terms that were overlooked by the system (false positives). The user can add substitutions currently missing (false negatives). For example, the user wishes to sanitize the term “littlerock.” Toward that end, the user specifies that the term “littlerock” is to be sanitized, and a new “pending” substitution is added to substitution list, see FIG. 5. The system automatically chooses a new term for the sanitized term, in this case, “city.” The user may then override this with his or her own choice of terms.

In general, the user can always change the labels to reflect his or her taste by overriding the program-suggested dummy terms in the substitution list pane. If the user wants to see the paragraphs where a certain sanitized term has appeared, he or she can, for example, right click on a particular substitution in the substitution list, and obtain the juxtaposed (e.g., side-by-side) view as shown in FIG. 6.

In FIG. 4, box 3, the user saves the current document as work-in-progress. This version is still not fully sanitized, nor is it finalized.

In FIG. 4, box, 4, the user now finalizes the document, which means that the user now accepts the current state of substitutions as final. At this point the bottom screen disappears from FIG. 4, and there is no trace to the original “old” terms. If one hovers over the substituted terms, one cannot any longer see the original, sanitized terms. FIG. 7 illustrates such a finalized document.

FIG. 5, as discussed above, is the display screen through which the sanitization/form generation process is managed. In the upper-right pane, a document with proposed substitutions is displayed on the computerized display device. Displayed within the document are general-case terms proposed to be substituted for specific-case terms originally existing in said document. Further displayed in the lower pane is a proposed substitution list listing the general-case terms in relation to the specific-case terms for which they are proposed to be substituted.

In the upper left pane, a context navigator enables a user to “jump” to a linked document portion by selecting (e.g., clicking on) a particular link. Navigator is provided as a tree structure or outline, such that a user may select a desired level of detail corresponding to individually presented document portions. The user may thus select portions of a document for applying sanitizing criteria to only the selected document subsections. Such ability to identify paragraphs, contract terms, portions of a patent application, and so on according to portion label, pattern, context or other identifiable document characteristics may also be used by the sanitizer to identify and provide links to predetermined or selectable document subsections, including but not limited to those illustrated.

Based on this, as discussed above, it is possible to undo a proposed substitution by selecting a proposed substitution to be undone. It is also possible to add a substitution by selecting a substitution to be added. It is also possible to modify a proposed substitution by selecting a proposed substitution to be modified, and entering a modification to the proposed substitution. And, it is possible to select a proposed general-case term within the display of the document (for example, by hovering over that term with a cursor), and, in response thereto, display the corresponding specific-case term.

The proposed substitution list provides for display and enabling user modification of sanitizing information including each general-case term and its corresponding specific-case term. User modification may be effectuated by entering and confirming a new specific-case term (false negative), checking a general and specific-case term pair to exclude the pair from substitution (false positive), or entering a different general-case substitution (new dummy) than the one proposed.

FIG. 6, as noted earlier, illustrates a document comparison window, enabling the user to directly compare the source document with a proposed output (sanitized or form) document. This view presents all portions, or only sanitized portions, or selected portions, of the document in process. In the illustrated example, the AKA1/Morfax substitution has been selected, and so a proposed sanitized markup including replacement items is presented showing only those sections where the AKA1/Morfax substitution is proposed to take place. The display of the source document includes a highlighted display of the sanitized source items. This document comparison window further highlights the proposed substitutions (via, e.g., bolding for purposes of the present example), provides location information for each paragraph via line numbering (lower right of each section) or some similar location and/or context information, and displays ordered and highlighted links for presenting corresponding portions of a selected document version.

More generally, FIG. 6 illustrates displaying at least part of a source document on a computerized display device; displaying within the source document, specific-case terms for which it is proposed to substitute general-case terms; further displaying on the computerized display device, at least part of a proposed substitution document; and displaying within the proposed substitution document, the general-case terms proposed to be substituted for the specific-case terms, juxtaposed relative to the specific-case terms to facilitate comparison between the specific-case terms and the general-case terms.

The sanitizer may also provide for replacing fewer than all occurrences of a specific-case term with a genera-case term, where, for example, where not all occurrences are found by the sanitizer or a user to be sensitive. In this event, linkages are still maintained among all occurrences of a specific-case term which is replaced. An example of this is the earlier-noted example of “Delaware.” It may be that Delaware appears in two contexts: one as the state of incorporation which does not need to be sanitized, and another as the state of residence of one of the parties, which does need to be sanitized. The ability to sanitize less than all occurrences, therefor, becomes necessary in such a case. So too, if all the “Delawares” were to be sanitized, is the ability to decouple one set of substitutions from another, that is, to substitute different dummy terms for “Delaware,” depending whether it is being used as the state of incorporation, or as the state of residence of one of the parties.

Once the user is satisfied with the proposed substitution and has made any deletions, additions, or changes to the substitution list, the user uses the user input device to ask for the document to be finalized (FIG. 4, box 4). The document may be finalized as a sanitized document (FIG. 7) or as a form (FIG. 8), as has been elaborated earlier. As noted earlier, the form may subsequently be used to generate new documents by inserting new specific-case information into the various form fields.

In a batch processing embodiment, the user may submit a large number of documents for sanitization and/or form generation all at the same time, and then receive a report (e.g., proposed substitution list) covering all document in the batch. Then, when the user approves (or adds) a particular substitution, that substitution will be made throughout all of the documents in the batch, and not merely to a single document. In this way, law firms and other users with large collections of documents to sanitize may sanitize a whole collection of document in a single batch, and may do so in a manner that is thoroughly consistent from one document to the next.

Although the invention has been discussed with reference to specific embodiments thereof, these embodiments are merely illustrative, and not restrictive, of the invention. For example, although a preferred embodiment strives to identify and substitute all specific-term occurrences, in other embodiments it may be desirable to replace less than the total number of occurrences of a term. For example, only occurrences in certain areas of a document might be replaced. Or replacements or substitutions may be limited to a predetermined number or threshold (e.g., the first or last n occurrences). Different general-case terms can be used to replace occurrences of one specific-case term. Or a single general-case term might be used for multiple different specific-case terms. Many other variations are possible.

Although embodiments of the invention are discussed with respect to text substitution, other types of information can be the subject of various features and functionality described herein. For example, images, audio, video or other types of media can be similarly processed if represented in electronic form within a document, file, program or other data source. Documents that include functional symbols and data, such as word-processing documents, Hypertext Markup Language (HTML) documents, program code or scripts such as Java, etc., can have tags, meta-data, commands, macros, comments, tracked changes, author information, formatting, and other information that can be the subject of identification and substitution. Use of the labels “specific-case term” or “general-case term” should be regarded to include any type of information representation capable of being processed, even to the extent where the general-case term is more “specific” than the specific-case term and vice versa.

The degree to which functions are performed manually or automatically can be modified, as desired. Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. It may also include a telecommunications link through which a program file or a program installation file is downloaded from a remote location precedent to installing a program.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application-specific integrated circuits, programmable logic devices, field programmable gate arrays, optical, chemical, biological, and/or quantum or nanoengineered systems, components and mechanisms. In general, the functions of the present invention can be achieved by any means as is known in the art, or may become known in the art in the future. Distributed, or networked systems, components and circuits can be used. Communication or transfer of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While only certain preferred features of the invention have been illustrated and described, many modifications and changes will occur to those skilled in the art. It is, therefore, to be understood that the appended claims are intended to cover all such modifications and changes as fall within the true spirit of the invention.

1. A method of converting specific-case information to general-case information, comprising the steps of:
identifying specific-case terms by scanning through at least one source document, using a computer processor;
proposing substitutions of general-case terms for the identified specific-case terms in said at least one source document, also using said computer processor; and
displaying the proposed substitutions for said at least one source document, on a computerized display device.

2. The method of, said step of substituting further comprising the step of:
for all identified occurrences of a particular specific-case term, uniformly substituting a general-case term therefor.

3. The method of, wherein:
said specific-case terms comprise sensitive identifying terms to be sanitized from said source document; and
said general-case terms comprise sanitization terms for concealing said sensitive identifying terms.

4. The method of, further comprising the step of:
displaying a form field in connection with each proposed substitution.

5. The method of, further comprising the steps of:
maintaining linkages among all form fields connected with the proposed substitutions for a particular specific-case term;
entering a new specific-case term into one of the linked form fields using a computerized input device; and
automatically filing said new specific-case term into all of the form fields linked to said one of said linked form fields.

6. The method of, further comprising the steps of:
passing said linkages to a computerized form program; and
entering and automatically filling using said computerized form program.

7. The method of. said step of identifying specific-case terms further comprising the steps of:
comparing terms in said source document with names in a name database; and
identifying a term as a specific-case term based on said term matching a name in said name database.

8. The method of, further comprising the step of:
deriving said name database from a corpus of a large number of documents of similar nature to said source document.

9. The method of. said step of identifying specific-case terms further comprising the steps of:
comparing terms in said source document with patterns in a pattern grammar database; and
identifying a term as a specific-case term based on said term matching a grammar pattern in said grammar pattern database.

10. The method of, wherein said grammar pattern is selected from the grammar group consisting of: a city, state, zip pattern; a city, sate pattern, a price pattern, a name pattern; and a date pattern.

11. The method of. said step of identifying specific-case terms further comprising the steps of:
identifying a particular section of said source document as being a section customarily containing specific-case terms; and
identifying a term as a specific-case term based on said term being located in the identified particular section at a place customarily occupied by specific-case terms.

12. The method of. said step of identifying specific-case terms further comprising the steps of:
comparing terms in said source document with terms in a collocation database; and
identifying a term as a specific-case term based on said term matching a term in said collocation database.

13. The method of, further comprising the step of:
deriving said collocation database from a corpus of a large number of documents of similar nature to said source document.

14. The method of, further comprising the step of:
further identifying said term as a specific-case term based on the collocation of said term being used below a predetermined usage threshold.

15. The method of, further comprising the step of:
establishing said predetermined usage threshold using a computerized input device.

16. The method of, said step of identifying specific-case terms further comprising the steps of:
comparing terms in said source document with terms in a rare word database; and
identifying a term as a specific-case term based on said term matching a term in said rare word database which is used below a predetermined usage threshold.

17. The method of, further comprising the step of:
deriving said rare word database from a corpus of a large number of documents of similar nature to said source document.

18. The method of, further comprising the step of:
establishing said predetermined usage threshold using a computerized input device.

19. The method of, further comprising the step of:
classifying specific-case terms according to a plurality of types of specific-case terms;
selecting which types of specific-case terms are to be identified for proposed substitution; and
identifying for proposed substitution, only terms which fall within one of the selected types of specific-case terms.

20. The method of, wherein said plurality of types of specific-case terms is selected from at least two members of the specific-case type group consisting of: names; addresses; cities; states; countries; postal codes; dates; prices; collocations rare words; and terms in sections of said source document customarily containing specific-case terms.

21. The method of, further comprising the step of:
undoing a proposed substitution by designating a proposed substitution to be undone, using a computerized input device.

22. The method of, further comprising the step of:
adding a substitution by designating a substitution to be added, using a computerized input device.

23. The method of, further comprising the step of:
modifying a proposed substitution by designating a proposed substitution to be modified, using a computerized input device; and
entering a modification to said proposed substitution, using said computerized input device.

24. The method of, further comprising the steps of:
overriding a proposed substitution;
learning from said overriding using machine learning; and
thereafter, applying said machine learning to said step of proposing substitutions.

25. The method of, further comprising the steps of:
designating a proposed substitution on said computerized display device, using a computerized input device; and
in response to said designating, displaying the specific-case term for which said proposed substitution is proposed, on said computerized display device.

26. The method of, further comprising the step of:
finalizing said source document into a finalized document by initiating finalization, using a computerized input device; and
thereafter, barring a computerized output of said finalized document from revealing all specific-case terms for which substitutions have been made and finalized.

27. The method of, further comprising the step of:
displaying a form field in connection with each finalized substitution.

28. The method of, further comprising the steps of:
maintaining linkages among all form fields connected with the finalized substitutions for a particular specific-case term;
entering a new specific-case term into one of the linked form fields using a computerized input device; and
automatically filing said new specific-case term into all of the form fields linked to said one of said linked form fields.

29. The method of, further comprising the steps of:
passing said linkages to a computerized form program; and
entering and automatically filling using said computerized form program.

30. The method of, further comprising the steps of:
displaying said source document on said computerized display device;
displaying within said source document, said general-case terms proposed to be substituted for said specific-case terms; and
further displaying on said computerized display device, a list of said proposed substitutions listing said general-case terms in relation to said specific-case terms for which they are proposed to be substituted.

31. The method of, further comprising the steps of:
displaying at least part of said source document on said computerized display device;
displaying within said source document, said specific-case terms for which it is proposed to substitute said general-case terms;
further displaying on said computerized display device, at least part of a proposed substitution document; and
displaying within said proposed substitution document, said proposed substitutions, with said specific-case terms juxtaposed relative to said general-case terms to facilitate comparison therebetween.

32. The method of, further comprising the steps of:
identifying said specific-case terms by scanning through a batch plurality of source documents, using said computer processor;
proposing substitutions of general-case terms for the identified specific-case terms in said batch plurality of source documents, also using said computer processor; and
displaying the proposed substitutions for said batch plurality of source documents, on said computerized display device.

33. A method of interfacing a user with a computer for converting specific-case information to general-case information, comprising the steps of:
displaying a source document on a computerized display device;
displaying within said source document, general-case terms proposed to be substituted for specific-case terms originally existing in said source document, based on processing by a computer processor; and
further displaying on said computerized display device, a proposed substitution list listing said general-case terms in relation to said specific-case terms for which they are proposed to be substituted.

34. The method of, further comprising the step of:
further displaying for a particular general-case term and its related specific-case term, how many times said particular general-case term is proposed to be substituted for said related specific-case term.

35. The method of, further comprising the step of:
undoing a proposed substitution by designating a proposed substitution to be undone, using a computerized input device.

36. The method of, further comprising the step of:
adding a substitution by designating a substitution to be added, using a computerized input device.

37. The method of, further comprising the steps of:
modifying a proposed substitution by designating a proposed substitution to be modified, using a computerized input device; and
entering a modification to said proposed substitution, using said computerized input device.

38. The method of, further comprising the steps of:
designating a proposed general-case term within said display of said source document, using a computerized input device; and
in response to said designating, displaying the corresponding specific-case term, on said computerized display device.

39. The method of, further comprising the step of:
within said source document, for all occurrences of a particular specific-case term, displaying a uniform general-case term substitution therefor.

40. The method of, further comprising the step of:
displaying a form field in connection with each general-case term proposed to be substituted for a specific-case term.

41. The method of, further comprising the steps of:
entering a new specific-case term into a particular form field using a computerized input device; and
automatically filing said new specific-case term into all of the form fields which originally contained the same specific-case term as said particular form field.

42. The method of, further comprising the step of:
barring a computerized output of a finalized document from revealing all specific-case terms for which substitutions have been made, once said source document has been finalized.

43. A method of interfacing a user with a computer for converting specific-case information to general-case information, comprising the steps of:
displaying at least part of a source document on a computerized display device;
displaying within said source document, specific-case terms for which it is proposed to substitute general-case terms, based on processing by a computer processor;
further displaying on said computerized display device, at least part of a proposed substitution document; and
displaying within said proposed substitution document, said general-case terms proposed to be substituted for said specific-case terms, juxtaposed relative to said specific-case terms to facilitate comparison between said specific-case terms and said general-case terms.

44. The method of, further comprising the steps of:
displaying a subset of said source document and a corresponding subset of said proposed substitution document, showing selected particular proposed substitutions of general-case terms for specific-case terms.

45. A method of interfacing a user with a computer for converting specific-case information to general-case information, comprising the step of:
displaying on a computerized display device, a proposed substitution list listing general-case terms proposed to be substituted for specific-case terms originally existing in at least one source document, in relation to said specific-case terms for which they are proposed to be substituted, based on processing by a computer processor.

46. The method of:
said at least one source document comprising a batch plurality of source documents; and
said proposed substitution list comprising proposed substitutions for said batch plurality of source documents.

47. The method of, further comprising the step of:
further displaying for a particular general-case term and its related specific-case term, how many times said particular general-case term is proposed to be substituted for said related specific-case term.

48. The method of, further comprising the step of:
undoing a proposed substitution by designating a proposed substitution to be undone, using a computerized input device.

49. The method of, further comprising the step of:
adding a substitution by designating a substitution to be added, using a computerized input device.

50. The method of, further comprising the steps of:
modifying a proposed substitution by designating a proposed substitution to be modified, using a computerized input device; and
entering a modification to said proposed substitution, using said computerized input device.

51. A computerized apparatus for converting specific-case information to general-case information, comprising:
a computer processor identifying specific-case terms by scanning through at least one source document;
said computer processor also proposing substitutions of general-case terms for the identified specific-case terms in said at least one source document; and
a computerized display device displaying the proposed substitutions for said at least one source document.

52. The computerized apparatus of, further comprising:
said computer processor uniformly substituting a general-case term for all identified occurrences of a particular specific-case term.

53. The computerized apparatus of:
said specific-case terms comprising sensitive identifying terms to be sanitized from said source document; and
said general-case terms comprising sanitization terms for concealing said sensitive identifying terms.

54. The computerized apparatus of, further comprising:
said computerized display device displaying a form field in connection with each proposed substitution.

55. The computerized apparatus of, further comprising:
said computerized apparatus maintaining linkages among all form fields connected with the proposed substitutions for a particular specific-case term;
a computerized input device for entering a new specific-case term into one of the linked form fields; and
said computerized apparatus automatically filing said new specific-case term into all of the form fields linked to said one of said linked form fields.

56. The computerized apparatus of, further comprising:
a computerized form program receiving a passing of said linkages thereto; and
said computerized form program for said entering and said automatically filling.

57. The computerized apparatus of. further comprising:
said computer processor comparing terms in said source document with names in a name database; and
said computer processor identifying a term as a specific-case term based on said term matching a name in said name database.

58. The computerized apparatus of, further comprising:
said name database, derived from a corpus of a large number of documents of similar nature to said source document.

59. The computerized apparatus of. further comprising:
said computer processor comparing terms in said source document with patterns in a pattern grammar database; and
said computer processor identifying a term as a specific-case term based on said term matching a grammar pattern in said grammar pattern database.

60. The computerized apparatus of, said grammar pattern selected from the grammar group consisting of: a city, state, zip pattern; a city, sate pattern, a price pattern, a name pattern; and a date pattern.

61. The computerized apparatus of. further comprising:
said computer processor identifying a particular section of said source document as being a section customarily containing specific-case terms; and
said computer processor identifying a term as a specific-case term based on said term being located in the identified particular section at a place customarily occupied by specific-case terms.

62. The computerized apparatus of. further comprising:
said computer processor comparing terms in said source document with terms in a collocation database; and
said computer processor identifying a term as a specific-case term based on said term matching a term in said collocation database.

63. The computerized apparatus of, further comprising:
said collocation database, derived from a corpus of a large number of documents of similar nature to said source document.

64. The computerized apparatus of, further comprising:
said computer processor further identifying said term as a specific-case term based on the collocation of said term being used below a predetermined usage threshold.

65. The computerized apparatus of, further comprising:
a computerized input device for establishing said predetermined usage threshold.

66. The computerized apparatus of, further comprising:
said computer processor comparing terms in said source document with terms in a rare word database; and
said computer processor identifying a term as a specific-case term based on said term matching a term in said rare word database which is used below a predetermined usage threshold.

67. The computerized apparatus of, further comprising:
said rare word database, derived from a corpus of a large number of documents of similar nature to said source document.

68. The computerized apparatus of, further comprising:
a computerized input device for establishing said predetermined usage threshold.

69. The computerized apparatus of, further comprising:
said computerized apparatus classifying specific-case terms according to a plurality of types of specific-case terms;
said computer processor selecting which types of specific-case terms are to be identified for proposed substitution; and
said computer processor identifying for proposed substitution, only terms which fall within one of the selected types of specific-case terms.

70. The computerized apparatus of, said plurality of types of specific-case terms selected from at least two members of the specific-case type group consisting of: names; addresses; cities; states; countries; postal codes; dates; prices; collocations rare words; and terms in sections of said source document customarily containing specific-case terms.

71. The computerized apparatus of, further comprising:
a computerized input device for undoing a proposed substitution by designating a proposed substitution to be undone.

72. The computerized apparatus of, further comprising:
a computerized input device for adding a substitution by designating a substitution to be added.

73. The computerized apparatus of, further comprising:
a computerized input device for modifying a proposed substitution by designating a proposed substitution to be modified; and
said computerized input device for entering a modification to said proposed substitution.

74. The computerized apparatus of, further comprising:
a computerized input device for overriding a proposed substitution;
a machine learning program learning from said overriding; and
said machine learning program thereafter applying said machine learning to said computer processor proposing substitutions.

75. The computerized apparatus of, further comprising:
a computerized input device for designating a proposed substitution on said computerized display device; and
said computerized display device, in response to said designating, displaying the specific-case term for which said proposed substitution is proposed.

76. The computerized apparatus of, further comprising:
a computerized input device for initiating finalization and thereby finalizing said source document into a finalized document; and
thereafter, said computerized apparatus barring a computerized output of said finalized document from revealing all specific-case terms for which substitutions have been made and finalized.

77. The computerized apparatus of, further comprising:
said computerized display device displaying a form field in connection with each finalized substitution.

78. The computerized apparatus of, further comprising:
said computerized apparatus maintaining linkages among all form fields connected with the finalized substitutions for a particular specific-case term;
a computerized input device for entering a new specific-case term into one of the linked form fields; and
said computerized apparatus automatically filing said new specific-case term into all of the form fields linked to said one of said linked form fields.

79. The computerized apparatus of, further comprising:
a computerized form program receiving a passing of said linkages thereto; and
said computerized form program for said entering and said automatically filling.

80. The computerized apparatus of, further comprising:
said computerized display device displaying said source document;
said computerized display device displaying within said source document, said general-case terms proposed to be substituted for said specific-case terms; and
said computerized display device further displaying a list of said proposed substitutions listing said general-case terms in relation to said specific-case terms for which they are proposed to be substituted.

81. The computerized apparatus of, further comprising:
said computerized display device displaying at least part of said source document;
said computerized display device displaying within said source document, said specific-case terms for which it is proposed to substitute said general-case terms;
said computerized display device further displaying at least part of a proposed substitution document; and
said computerized display device displaying within said proposed substitution document, said proposed substitutions, with said specific-case terms juxtaposed relative to said general-case terms to facilitate comparison therebetween.

82. The computerized apparatus of, further comprising:
said computer processor identifying said specific-case terms by scanning through a batch plurality of source documents;
said computer processor also proposing substitutions of general-case terms for the identified specific-case terms in said batch plurality of source documents; and
said computerized display device displaying the proposed substitutions for said batch plurality of source documents.

83. A computerized apparatus for interfacing a user with a computer for converting specific-case information to general-case information, comprising:
a computerized display device displaying a source document;
said computerized display device displaying within said source document, general-case terms proposed to be substituted for specific-case terms originally existing in said source document, based on processing by a computer processor; and
said computerized display device further displaying a proposed substitution list listing said general-case terms in relation to said specific-case terms for which they are proposed to be substituted.

84. The computerized apparatus of, further comprising:
said computerized display device further displaying for a particular general-case term and its related specific-case term, how many times said particular general-case term is proposed to be substituted for said related specific-case term.

85. The computerized apparatus of, further comprising:
a computerized input device for undoing a proposed substitution by designating a proposed substitution to be undone.

86. The computerized apparatus of, further comprising:
a computerized input device for adding a substitution by designating a substitution to be added.

87. The computerized apparatus of, further comprising:
a computerized input device for modifying a proposed substitution by designating a proposed substitution to be modified; and
said computerized input device for entering a modification to said proposed substitution.

88. The computerized apparatus of, further comprising:
a computerized input device for designating a proposed substitution on said computerized display device; and
said computerized display device, in response to said designating, displaying the specific-case term for which said proposed substitution is proposed.

89. The computerized apparatus of, further comprising:
said computerized display device displaying a uniform general-case term substitution for all occurrences of a particular specific-case term within said source document.

90. The computerized apparatus of, further comprising:
said computerized display device displaying a form field in connection with each general-case term proposed to be substituted for a specific-case term.

91. The computerized apparatus of, further comprising:
a computerized input device for entering a new specific-case term into a particular form field; and
said computerized apparatus automatically filing said new specific-case term into all of the form fields which originally contained the same specific-case term as said particular form field.

92. The computerized apparatus of, further comprising:
said computerized apparatus barring a computerized output of a finalized document from revealing all specific-case terms for which substitutions have been made, once said source document has been finalized.

93. A computerized apparatus for interfacing a user with a computer for converting specific-case information to general-case information, comprising:
a computerized display device displaying at least part of a source document;
said computerized display device displaying within said source document, specific-case terms for which it is proposed to substitute general-case terms, based on processing by a computer processor;
said computerized display device further displaying at least part of a proposed substitution document; and
said computerized display device displaying within said proposed substitution document, said general-case terms proposed to be substituted for said specific-case terms, juxtaposed relative to said specific-case terms to facilitate comparison between said specific-case terms and said general-case terms.

94. The computerized apparatus of, further comprising:
said computerized display device displaying a subset of said source document and a corresponding subset of said proposed substitution document, showing selected particular proposed substitutions of general-case terms for specific-case terms.

95. A computerized apparatus for interfacing a user with a computer for converting specific-case information to general-case information, comprising:
a computerized display device displaying a proposed substitution list listing general-case terms proposed to be substituted for specific-case terms originally existing in at least one source document, in relation to said specific-case terms for which they are proposed to be substituted, based on processing by a computer processor.

96. The computerized apparatus of:
said at least one source document comprising a batch plurality of source documents; and
said proposed substitution list comprising proposed substitutions for said batch plurality of source documents.

97. The computerized apparatus of, further comprising:
said computerized display device further displaying for a particular general-case term and its related specific-case term, how many times said particular general-case term is proposed to be substituted for said related specific-case term.

98. The computerized apparatus of, further comprising:
a computerized input device for undoing a proposed substitution by designating a proposed substitution to be undone.

99. The computerized apparatus of, further comprising:
a computerized input device for adding a substitution by designating a substitution to be added.

100. The computerized apparatus of, further comprising:
a computerized input device for modifying a proposed substitution by designating a proposed substitution to be modified; and
said computerized input device for entering a modification to said proposed substitution.

101. A computer-readable medium comprising computer-executable instructions for:
identifying specific-case terms by scanning through at least one source document, using a computer processor;
proposing substitutions of general-case terms for the identified specific-case terms in said at least one source document, also using said computer processor; and
displaying the proposed substitutions for said at least one source document, on a computerized display device.

102. A computer-readable medium comprising computer-executable instructions for:
displaying a source document on a computerized display device;
displaying within said source document, general-case terms proposed to be substituted for specific-case terms originally existing in said source document, based on processing by a computer processor; and
further displaying on said computerized display device, a proposed substitution list listing said general-case terms in relation to said specific-case terms for which they are proposed to be substituted.

103. A computer-readable medium comprising computer-executable instructions for:
displaying at least part of a source document on a computerized display device;
displaying within said source document, specific-case terms for which it is proposed to substitute general-case terms, based on processing by a computer processor;
further displaying on said computerized display device, at least part of a proposed substitution document; and
displaying within said proposed substitution document, said general-case terms proposed to be substituted for said specific-case terms, juxtaposed relative to said specific-case terms to facilitate comparison between said specific-case terms and said general-case terms.

104. A computer-readable medium comprising computer-executable instructions for:
displaying on a computerized display device, a proposed substitution list listing general-case terms proposed to be substituted for specific-case terms originally existing in at least one source document, in relation to said specific-case terms for which they are proposed to be substituted, based on processing by a computer processor.
